(19) United States
(12) Patent Application Publication
(10) Pub. No.: US 2013/0261267 A1
(43) Pub. Date: Oct. 3, 2013

(54) CONTROLLED RADICAL POLYMERIZATION OF HALOGENATED MONOMERS

(71) Applicants: Vincent Bodart, Namur (BE); Yasmine Piette, Embourg (BE); Christophe Detrembleur, Esneux (BE); Antoine Debuigne, Buzet (Floreffe) (BE); Christine Jerome, Ougree (BE)

(72) Inventors: Vincent Bodart, Namur (BE); Yasmine Piette, Embourg (BE); Christophe Detrembleur, Esneux (BE); Antoine Debuigne, Buzet (Floreffe) (BE); Christine Jerome, Ougree (BE)

(73) Assignee: Universite De Liege, Liege (BE)

(21) Appl. No.: 13/992,409

(22) PCT Filed: Dec. 6, 2011
(86) PCT No.: PCT/EP11/71954

§ 371 Date: Jun. 7, 2013

(30) Foreign Application Priority Data
Dec. 7, 2010 (EP) 10194046.8

(51) Int. Cl. C08F 4/42

(52) U.S. Cl. CPC C08F 4/42
USPC 525/292; 526/172; 525/359.3

(57) ABSTRACT

Process for the preparation of a halogenated polymer comprising a controlled radical polymerization step of at least one monomer containing at least one halogen-carbon bond, performed in the presence of an organo-cobalt complex, said polymerization step being further carried out in non-isotherm conditions.

This application claims priority to European application No. 10194046.8 filed on Dec. 7, 2010, the whole content of this application being incorporated herein by reference for all purposes.

The present invention relates to a process for the preparation of a halogenated polymer comprising a controlled radical polymerization (CRP) step of at least one monomer containing a halogen-carbon bond. Further objects of the invention are the preparation of certain random copolymers of monomers containing a halogen-carbon bond with vinyl esters comprising such a CRP step, as well as these random copolymers themselves. Still further objects of the invention are the preparation of certain block copolymers comprising segments of a halogenated polymer and segments of a vinyl ester-containing polymer by making use of such a CRP step modified accordingly, as well as these block copolymers themselves.

Many halogenated polymers of industrial and commercial importance, such as homo- and copolymers of vinyl and vinylidene halides, polymers of halogenated alpha-olefins, for instance polymers of fluoro- and chlorofluoroethylenes, and the like, are obtainable by conventional free radical polymerization processes. Conventional free radical polymerization (more simply called <<conventional radical polymerization>> hereafter) is a process by which a polymer is formed from the successive addition of monomeric units through a free radical mechanism. Free radicals are mainly formed via mechanisms involving initiator molecules which generate radicals. Following creation of free radical monomeric units by the binding of the initiator radical with a monomer molecule (=initiation step), polymer chains grow rapidly with successive addition of monomeric units onto free radical sites (=propagation step). Conventional radical polymerization includes also termination and sometimes also chain transfer reactions.

One major drawback of conventional radical polymerization is that control of the molecular architecture of the polymer is almost impossible, making its macroscopic properties very difficult to be tailored. This is particularly true for the conventional radical polymerization of vinyl monomers because of the high reactivity of the propagating radical, resulting from the lack of stabilizing groups. Furthermore, transfer reactions towards the monomer and the growing polymer generate structural defects along the polymer chains. When vinyl monomers to be polymerized are selected among vinyl or vinylidene halides, these structural defects are for instance halogen atoms in allylic position, in beta position with respect of another halogen atom or binded to tertiary carbon atoms. These structural defects along the polymer chains accelerate the thermal degradation of the corresponding halogenated polymers.

Research effort has already been made to overcome these drawbacks. Hence, controlled radical polymerization (CRP) processes have been developed since the early 1980s. In principle, conventional radical polymerization can be turned into CRP if the following requirements are fulfilled: (a) the rate of initiation is faster than that of propagation, so that all macromolecular chains form and grow simultaneously; (b) the concentration of active radical is low in order to slow down termination reactions; (c) the concentration of propagating chains is high so only a small fraction of them are terminated; (d) the polymerization system remains sufficiently homogeneous, so that the active centers are readily available.

CRP processes are also sometimes called living radical polymerization, controlled/living radical polymerization or more recently reversible-deactivation radical polymerization processes (IUPAC Recommendations 2010—Pure Appl. Chem., vol. 82, no 2, pp. 483-491, 2010 incorporated herein by reference).

Specific terms have then been used to describe specific types of controlled radical polymerisation. Among them may be cited atom transfer radical polymerization (ATRP), nitroxide-mediated (radical) polymerization (NM(R)P), aminoxyl-mediated (radical) polymerization (AM(R)P), reversible addition fragmentation chain transfer polymerization (RAFT), stable free radical polymerization (SFRP) also called stable radical mediated polymerization (SRMP), iodine transfer polymerization (ITP), reversible iodine transfer polymerization (RITP), macromolecular design via the interchange of xanthates (MADIX), single-electron transfer-degenerative chain transfer living radical polymerization (SET-DTLRP) and single electron transfer-living radical polymerization (SET-LRP) as developed by Percec et all based on activation and deactivation of the propagating chains by copper species issued from disproportionation, and organometallic-mediated radical polymerization (OMRP) among which cobalt-mediated radical polymerization (CMRP) which involves advantageously the formation of a reversible carbon-cobalt bond at the polymer chain-end.

Comprehensive and extensive reviews of CRP have been made in the literature and for instance as far as CMRP is concerned by A. Debuigne et al. in <<Overview of cobalt-mediated radical polymerization: Roots, state of the art and future prospects>>, Progress in Polymer Science 34 (2009) 211-239, doi: 10.1016/j.progpolymsci.2008.11.003 (document 1).

Effective CMRP of acrylic esters, acrylic acid, vinyl esters and acrylonitrile have been reported (see document 1). As far as vinyl esters are concerned, effective CMRP of vinyl acetate in aqueous suspension has been reported by A. Debuigne et al. in Angew. Chem. Int. Ed. 2005, 44, 3439-3442, doi: 10.1002/anie.200500112 (document 2); and the fast formation of stable poly(vinyl acetate) latexes by CMRP of vinyl acetate in miniemulsion has been described by C. Detrembleur et al. In Macromol. Rapid Commun. 2006, 27, 37-41, doi: 10.1002/imarc.200500645.

According to Applicant's knowledge, no report whatsoever has been made about any successful CMRP of vinyl and vinylidene halides, even if A. Debuigne et al. speculated that the CMRP of vinyl acetate in aqueous suspension they described in document 2 would be extendable to vinyl chloride (VC).

This is understandable: controlling the radical polymerization of VC has been highly challenging for years, because of the high reactivity of poly(vinyl chloride) (PVC) propagating radical due to the lack of stabilizing groups. Moreover, besides being a non-activated monomer, VC is also characterized by one of the largest transfer constant to monomer (i.e. between 3×10⁻⁴ and 5×10⁻³) among all conventional monomers (figures according to Brandrup, J. et al., 1999, Polymer Handbook, 4th Edition, Wiley, New York.), that strongly complicates attempts to control its polymerization.

The CMRP system, disclosed in document 2 (using 2,2′-azobis(4-methoxy-2,4-dimethylvaleronitrile (V 70) as azo initiator and cobalt acetylacetonate [Co(acac)₂] as controlling agent) and successfully used for controlling the radical polymerization of vinyl acetate, has been found rather inefficient to control the radical polymerization of VC (no evolution of molecular weight with conversion and polymerization inhibited at low conversion).

Other attempts to control the radical polymerization of VC with nitroxides have been made (see document WO 02/38632 A1). Although some control was achieved, the high temperatures required for this nitroxide-mediated polymerization (NMP) did not allow getting polymers featuring molecular parameters enhanced with respect to the ones obtained by uncontrolled free radical polymerization of VC. For instance, no obvious average molecular weight (Mₙ) evolution with conversion was observed, while the molecular weight distribution values were around 2.2. NMP of vinyl chloride also led to PVC with low thermal stability. Here again, NMP does not appear to be well suited for the CRP of VC because the covalent bond between the nitroxide and the polymer chains is not labile enough.

The present invention aims to overcome the above-mentioned drawbacks by providing a process for the manufacture of halogenated polymers where the polymeric chains are progressively growing with the monomer conversion, without structural defects, said process thus efficiently controlling the molecular parameters of said polymers.

Accordingly, in its main aspect, the present invention relates to a process for the preparation of a halogenated polymer, and the halogenated polymer prepared in accordance with this process, comprising a controlled radical polymerization (CRP) step of at least one monomer containing at least one halogen-carbon bond, performed in the presence of an organo-cobalt complex, said polymerization step being further carried out in non-isotherm conditions.

By the expression “CRP in the presence of an organo-cobalt complex”, it is meant in the present description, cobalt-mediated radical polymerization (CMRP).

In the present disclosure, the term “halogenated polymer(s)”, indifferently used in the singular or plural form, is intended to encompass either (a) homopolymers of monomers containing at least one halogen-carbon bond or (b) copolymers which said monomers form with one another or with nonhalogenated ethylenically unsaturated monomers; the terms “homopolymers” and “copolymers” being used indifferently in the singular or plural form. These copolymers (b) can in particular be (b1) random copolymers, (b2) block copolymers or (b3) grafted copolymers.

In the present disclosure, the term “monomer containing at least one halogen-carbon bond” must be understood as defining any ethylenically unsaturated monomer which comprises at least such a halogen-carbon bond. For the sake of brevity, the term “monomer containing at least one halogen-carbon bond” will be replaced, in the following part of the description and with exactly the same meaning, by the term “halogenated monomer”, indifferently used in the singular or plural form.

As examples of these halogenated monomers, reference may be made to halogenated vinyl monomers, halogenated styrene monomers, such as 4-bromostyrene, halogenated (meth)acrylic monomers, such as trifluoroethyl acrylate, and halogenated conjugated dienes, such as chloroprene.

The halogenated monomers are preferably halogenated vinyl monomers. In the present disclosure, the term “halogenated vinyl monomers” should be understood as defining aliphatic monoethylenically unsaturated monomers, containing at least one halogen-carbon bond and featuring thus, as sole heteroatom(s), one or more halogen atoms. As examples of these halogenated vinyl monomers, reference may be made to brominated vinyl monomers, such as vinyl bromide, fluorinated vinyl monomers and chlorinated vinyl monomers.

The halogenated monomers are particularly preferably chosen from chlorinated vinyl monomers. Non-limitative examples of chlorinated vinyl monomers are the chlorinated vinyl monomers in which the number of chlorine atoms is 1, the chlorinated vinyl monomers in which the number of chlorine atoms is 2, as well as trichloroethylene, 1,1,3-trichloropropene and tetrachloroethylene.

A first preferred family of chlorinated vinyl monomers is composed of monomers in which the number of chlorine atoms is 1. Non-limitative examples of chlorinated vinyl monomers in which the number of chlorine atoms is 1 are allyl chloride, crotyl chloride and, with a particular mention, vinyl chloride.

A second preferred family of chlorinated vinyl monomers is composed of monomers in which the number of chlorine atoms is 2. Non-limitative examples of chlorinated vinyl monomers for which the number of chlorine atoms is 2 are 1,1-dichloropropene, 1,3-dichloropropene, 2,3-dichloropropene and vinylidene chloride.

Most preferably, the at least one monomer containing at least one halogen-carbon bond is vinyl chloride.

As stated above, the halogenated polymer prepared in accordance with the process of the invention may optionally, in addition, comprise one or more nonhalogenated ethylenically unsaturated monomers. These nonhalogenated monomers are preferably chosen from styrene monomers such as styrene, (meth)acrylic monomers such as n-butyl acrylate and methyl methacrylate, vinyl esters such as vinyl acetate, and olefinic monomers, such as ethylene, propylene and butadiene. More preferably, the nonhalogenated monomer is chosen among vinyl esters; most preferably, the nonhalogenated monomer is vinyl acetate.

According to a first particular embodiment (embodiment 1), the present invention relates to a process for the preparation of a halogenated homopolymer (a) comprising a CRP step of one halogenated monomer, advantageously one halogenated vinyl monomer, preferably one chlorinated vinyl monomer in which the number of chlorine atoms is 1, most preferably vinyl chloride.

According to a second particular embodiment (embodiment 2), the present invention relates to a process for the preparation of a halogenated random copolymer (b1) comprising a CRP step of a mixture of a halogenated monomer and a nonhalogenated ethylenically unsaturated monomer. The halogenated monomer is advantageously a halogenated vinyl monomer, preferably a chlorinated vinyl monomer in which the number of chlorine atoms is 1, most preferably vinyl chloride. The nonhalogenated ethylenically unsaturated monomer is preferably a vinyl ester, more preferably vinyl acetate. According to this second particular embodiment, the present invention relates particularly to a process for the preparation of a halogenated random copolymer (b1) comprising a CRP step of a mixture of vinyl chloride and vinyl acetate.

Advantageously, halogenated random copolymer (b1) prepared in accordance with the process according to this second particular embodiment comprises at least 60 mole %, preferably at least 70 mole %, more preferably at least 80 mole % and most preferably at least 85 mole % of monomeric units derived from the halogenated monomer. Such halogenated random copolymer (b1) comprises preferably at least 70 mole %, more preferably at least 80 mole % of monomeric units derived from vinyl chloride and preferably at most 30 mole %, more preferably at most 20 mole % of monomeric units derived from vinyl acetate.

Halogenated random copolymer prepared in accordance with the process according to this second particular embodiment comprising at least 80 mole % by weight of monomeric units derived from vinyl chloride and at most 20 mole % by weight of monomeric units derived from vinyl acetate, is particularly preferred.

According to a third particular embodiment (embodiment 3), the present invention relates to a process for the preparation of a halogenated block copolymer (b2) comprising sequential CRP steps of (i) a halogenated monomer, (ii) a preformed or in-situ formed cobalt-containing macroinitiator (C3) (more thoroughly described hereafter) synthesized by CMRP of a nonhalogenated ethylenically unsaturated monomer and, optionally, (iii) the nonhalogenated ethylenically unsaturated monomer itself. The halogenated monomer is advantageously a halogenated vinyl monomer, preferably a chlorinated vinyl monomer in which the number of chlorine atoms is 1, most preferably vinyl chloride. The nonhalogenated ethylenically unsaturated monomer from which the macroinitiator (C3) derives is preferably a vinyl ester, more preferably vinyl acetate. According to this third particular embodiment, the present invention relates particularly to a process for the preparation of a halogenated block copolymer comprising sequential controlled radical polymerization steps of (i) vinyl chloride, (ii) a preformed or in-situ formed cobalt-containing macroinitiator synthesized by cobalt-mediated radical polymerization of vinyl acetate and, optionally, (iii) vinyl acetate itself.

According to a first alternative, the halogenated block copolymer (b2) prepared in accordance with the process according to embodiment 3 comprises homopolymeric segments (blocks) derived from a halogenated monomer and homopolymeric segments derived from a nonhalogenated ethylenically unsaturated monomer. According to a second alternative, the halogenated block copolymer (b2) prepared in accordance with the process according to embodiment 3 comprises homopolymeric segments derived from a halogenated monomer and segments of a halogenated random copolymer (b1).

The halogenated block copolymer (b2) prepared in accordance with the process according to embodiment 3 advantageously comprises from 25 to 75 weight % of units derived from the halogenated monomer and from 75 to 25 weight % of units derived from the nonhalogenated ethylenically unsaturated monomer.

Preferred halogenated block copolymer (b2) prepared in accordance with the process according to the first alternative of embodiment 3 comprises from 25 to 75 weight % of homopolymeric segments derived from vinyl chloride and 75 to 25 weight % of homopolymeric segments derived from vinyl acetate.

Preferred halogenated block copolymer (b2) prepared in accordance with the process according to the second alternative of embodiment 3 comprises from 25 to 75 weight % of homopolymeric segments derived from vinyl chloride and 75 to 25 weight % of copolymeric segments randomly derived from vinyl chloride and vinyl acetate in respective amounts similar to those mentioned above for the halogenated random copolymer (b1). More preferred halogenated block copolymer (b2) prepared in accordance with the process according to this second alternative comprises from 25 to 75 weight % of homopolymeric segments derived from vinyl chloride and 75 to 25 weight % of copolymeric segments randomly derived from vinyl chloride and vinyl acetate respectively presents in amounts of at least 60 mole % of monomeric units derived from vinyl chloride and at most 40 mole % of monomeric units derived from vinyl acetate.

The controlled radical polymerization step (also more simply called <<polymerization step>> or <<polymerization>> hereafter) comprised in the process of the present invention may be performed under any known operating conditions. Hence, the polymerization step may be performed:
in bulk, i.e. in the monomer(s) maintained in the liquid state;
in an aqueous medium; or
in a solvent for the monomer(s).

Preferably, the controlled radical polymerization step is performed in bulk or in an aqueous medium.

When the polymerization step is performed in an aqueous medium, it may be by the so-called suspension process, by the so-called emulsion process or by the so-called microsuspension process (also named homogenized aqueous dispersion process).

The terms “suspension process”, as used herein, are intended to define any polymerization of the halogenated monomer(s) and optional nonhalogenated ethylenically unsaturated monomer(s), carried out under agitation in an aqueous medium in the presence of dispersing agent(s) and optionally surfactant(s).

The terms “emulsion process”, as used herein, are intended to define any polymerization of the halogenated monomer(s) and optional nonhalogenated ethylenically unsaturated monomer(s) carried out under agitation in an aqueous medium in the presence of emulsifying agent(s).

The terms “microsuspension process”, as used herein, are intended to define any polymerization of the halogenated monomer(s) and optional nonhalogenated ethylenically unsaturated monomer(s) wherein an emulsion of monomer(s) droplets is created thanks to a mechanical vigorous agitation and the presence of emulsifying agent(s).

Other conventional additives may also be present during the radical polymerization step, such as for instance processing agents, anti-crusting agents, anti-foam agents, chain-transfer agents, antistatic agents, stabilizing agents, pH regulators, . . . .

The radical polymerization step comprised in the process of the invention is preferably carried out, especially when the halogenated monomer is vinyl chloride, either in the monomer(s) maintained in the liquid state or as a suspension process.

In accordance with the present invention, compounds able to initiate the radical polymerization of the monomer(s) are also advantageously added to the medium in which the polymerization is performed. These compounds are advantageously chosen among:
free radicals initiators (C1);
cobalt-containing compounds (C2) containing a primary radical derived from the initiator (C1); and
the above-mentioned macroinitiators (C3).

Compounds (C2) and macroinitiators (C3), besides being able to initiate the polymerization of the monomer(s), also contain an organo-cobalt complex moiety and consequently also advantageously happen to work as propagating agents during the polymerization step of the process of the invention. Accordingly, their chemical structures and preparation processes will be described later in the present specification.

As far as free radical initiators (C1) are concerned, use may be made of:
water-soluble free radicals initiators; these initiators are advantageously used in the emulsion process. Examples of water-soluble free radicals initiators are:
   water-soluble peroxides such as ammonium persulfate, sodium persulfate, potassium persulfate, aqueous hydrogen peroxide solution, perborates and the like;
   slightly water soluble organic initiators such as methyl ethyl ketone peroxide, 1-hydroperoxy-1′-hydroxydicyclohexyl peroxide and the like;
   water-soluble diazo compounds such as 4,4′-azobis(4-cyanovaleric acid), 2,2′-azobis[2-(2-imidazolin-2-yl)propane]dihydrochloride, 2,2′-azobis[2-(2-imidazolin-2-yl)propane]disulfate dihydrate, 2,2′-azobis[2-(2-imidazolin-2-yl)propane], 2,2′-azobis(N,N′-dimethyleneisobutyramidine)dihydrochloride, 2,2′-azobis(2-amidinopropane)dihydrochloride and the like;
   redox systems such as the redox couple hydrogen peroxide/Fe² and the like;
oil-soluble free radicals initiators; these initiators are advantageously used in the bulk and suspension processes. Examples of oil-soluble free radicals initiators are oil-soluble peroxy compounds such as
   dialkylperoxydicarbonates (dimethyl-, diethyl-, di-n-propyl-, di(isopropyl)-, di(sec-butyl)-, di(2-ethylhexyl)-, dimyristyl- and the like), dicetylperoxydicarbonate, dicyclohexylperoxydicarbonate, di(t-butyl-cyclohexyl)peroxydicarbonate, di(4-tert-butylcyclohexyl)peroxydicarbonate;
   dialkyl percarbonates such as tert-amylperoxy-2-ethylhexyl carbonate and tert-butylperoxyisopropyl carbonate;
   acetyl cyclohexane sulphonyl peroxide;
   dialkylperoxides (di-t-butylperoxide, dicumylperoxide and the like),
   diacyl peroxides such as diisononanoyl peroxide, dioctanoyl peroxide, didecanoyl peroxide, dilauroyl peroxide, di(2-methylbenzoyl)peroxide, dibenzoyl peroxide, di(4-chlorobenzoyl)peroxide and diisobutyriyl peroxide, and the like;
   peresters such as cumyl perneodecanoate, tert-amyl perneodecanoate, t-butylperoxy-n-decanoate, tert-amyl perpivalate, tert-butyl perpivalate, t-butylper-2-ethylhexanoate, t-butylperoxymaleate, tert-butyl perisobutyrate, tert-butyl perisononanoate, 2,5-dimethylhexane 2,5-diperbenzoate, tert-butyl perbenzoate and the like;
   perketals such as 1,1-bis(tert-butylperoxy)cyclohexane and 2,2-bis(tert-butylperoxy)butane;
   ketone peroxides such as cyclohexanone peroxide and acetyl acetone peroxide;
   organic hydroperoxides such as cumene hydroperoxide, tert-butyl hydroperoxide and pinane hydroperoxide;
   oil-soluble azo initiators such as 2,2′-azobis (4-methoxy-2.4-dimethyl valeronitrile), 2,2′-azobis (2.4-dimethyl valeronitrile), 2,2′-azobis(isobutyronitrile), 2,2′-azobis(2-cyano-2-butane), dimethyl 2,2′-azobisdimethylisobutyrate, dimethyl 2,2′-azobis(2-methylpropionate), 2,2′-azobis(2-methylbutyronitrile), 1,1′-azobis(cyclohexane-1-carbonitrile), 2,2′-azobis[N-(2-propenyl)-2-methylpropionamide], 1-[(1-cyano-1-methylethyl)azo]formamide, 2,2′-azobis(N-cyclohexyl-2-methylpropionamide), 2,2′-azobis(isobutyronitrile), 2,2′-azobis(2-cyano-2-butane), dimethyl 2,2′-azobisdimethylisobutyrate, 1,1′-azobis(cyclohexanecarbonitrile), 2-(t-butylazo)-2-cyanopropane, 2,2′-azobis[2-methyl-N-(1,1)-bis(hydroxymethyl)-2-hydroxyethyl]propionamide, 2,2′-azobis[2-methyl-N-hydroxyethyl]-proprionamide, 2,2′-azobis(N,N′-dimethyleneisobutyramine), 2,2′-azobis(2-methyl-N-[1,1-bis(hydroxymethyl)-2-hydroxyethyl]propionamide), 2,2′-azobis(2-methyl-N-[1,1-bis(hydroxymethyl)ethyl]proprionamide), 2,2′-azobis[2-methyl-N-(2-hydroxyethyl) propionamide], 2,2′-azobis(isobutyramide)dihydrate, 2,2′-azobis(2,2,4-trimethylpentane), 2,2′-azobis(2-methylpropane) and the like.

2,2′-azobis (4-methoxy-2.4-dimethyl valeronitrile) (V-70), diethylperoxydicarbonate and dilaurylperoxide are preferred as oil-soluble free radicals initiators.

In accordance with the invention, an organo-cobalt complex is also present in the medium in which the polymerization is carried out. In the present disclosure, the term “organo-cobalt complex” must be understood as defining any compound containing two or three β-diketonato ligands binded to a bivalent or trivalent cobalt ion to form a complex wherein cobalt is bound and coordinated to both oxygen atoms of each diketonato ligand which forms a six-membered chelate ring. The organo-cobalt complex advantageously generates carbon-cobalt bonds end-capping the growing polymer chains.

Preferably, the organo-cobalt complex is any compound containing two β-diketonato ligands binded to a bivalent or trivalent cobalt ion to form a complex wherein cobalt is bound and coordinated to both oxygen atoms of each diketonato ligand which forms a six-membered chelate ring.

The term “β-diketonato ligands”, also named 1,3-diketonato ligands, is to be understood in the present specification as commonly known i.e. bearing two carbonyl groups that are separated by one carbon atom (which is the α carbon).

The organo-cobalt complex is more preferably a cobalt (II) β-diketonate, an alkyl-cobalt (III) adduct or a cobalt-containing macroinitiator.

According to a first variant of the process according to the invention, the organo-cobalt complex is a cobalt (II) β-diketonate. The organo-cobalt complexes of this first group are advantageously the cobalt (II) β-diketonates represented by the following formula:

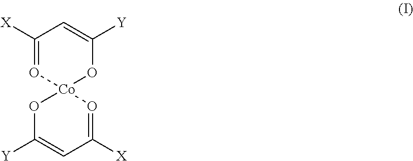

wherein each X and Y, if present, may be, independently from one another, chosen among alkyl radicals, especially —CH₃; isoalkyl radicals, especially —C(CH₃)₃ and fluoroalkyl radicals, especially —CF₃.

Examples of usable cobalt (II) β-diketonates are cobalt (II) bis (acetylacetonate); cobalt (II) bis (6,6,7,7,8,8,8,-heptafluoro-3,5-dimethyl-octanedionate); cobalt (II) bis (2,2,6,6-tetramethyl-3,5-heptanedionate); cobalt (II) bis (trifluoroacetylacetonate); cobalt (II) bis (hexafluoroacetylacetonate) and cobalt (II) bis (thenoyltrifluoroacetetonate). A preferred cobalt (II) β-diketonate is cobalt (II) bis (acetylacetonate), also referred to herein, for the sake of brevity, as “Co(acac)₂”

According to a second variant of the process according to the invention, the organo-cobalt complex is an alkyl-cobalt (III) adduct.

The organo-cobalt complexes of this second group are the cobalt-containing compounds (C2) referred to above (i.e. containing a primary radical derived from the free radicals initiator (C1)). These compounds (C2) are alkyl-cobalt (III) adducts which may be obtained for instance by reacting a free radicals initiator (C1) as listed above, preferably an oil-soluble free radicals initiator, with a cobalt (II) β-diketonate in a liquid medium containing a nonhalogenated ethylenically unsaturated monomer.

Co(acac)₂ is preferred as cobalt (II) β-diketonate. Preferred cobalt-containing compounds (C2) are therefore alkyl-cobalt (III) adducts represented by the formula

R—Co(acac)₂ (II)

wherein R comprises the primary radical derived from the decomposition of a free radicals initiator (C1) as listed above, preferably an oil-soluble free radicals initiator, and 1 to 5 monomeric units resulting from the nonhalogenated ethylenically unsaturated monomer.

Vinyl esters are preferred as nonhalogenated ethylenically unsaturated monomer, vinyl acetate being especially preferred. More preferred cobalt-containing compounds (C2) are therefore alkyl-cobalt (III) adducts represented by the formula

R₁—(CH₂—CHOCOCH₃)ₙ—Co(acac)₂ (III)

wherein n=1 to 5 and R₁ is a primary radical derived from the decomposition of a free radicals initiator as listed above, preferably of an oil-soluble free radicals initiator.

Oil-soluble free radicals initiators are preferred. Oil-soluble azo initiators are further preferred as oil-soluble free radicals initiators, 2,2′-azobis (4-methoxy-2,4-dimethyl valeronitrile (V-70)) being especially preferred.

A most preferred cobalt-containing compound (C2) is therefore obtained (according to A. Debuigne et al. in Chem. Eur. J. 2008, 14, 4046-4059, doi: 10.1002/chem. 200701867) by reacting V-70 with Co(acac)₂ in liquid vinyl acetate and corresponds to the following formula:

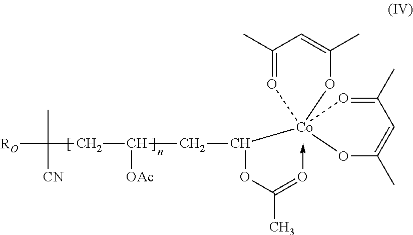

where R_{O}—C(CH₃)(CN)— is the primary radical (CH₃)₂(OCH₃)C—CH₂—C(CH₃)(CN)— resulting from the V-70 decomposition and n=3, 4 or 5.

According to a third variant of the process according to the invention, the organo-cobalt complex is a cobalt-containing macroinitiator.

The organo-cobalt complexes of this third group are the cobalt-containing macroinitiators (C3) referred to above, advantageously synthesized by CMRP of a nonhalogenated ethylenically unsaturated monomer.

The macroinitiators (C3) are cobalt-containing compounds responding to formulas (II) to (IV) here above in which the number of monomeric units resulting from the nonhalogenated ethylenically unsaturated monomer is higher than 5, with the same definitions and preferences as defined for cobalt-containing compounds (C2).

The macroinitiators (C3) may be prepared in accordance with either of the following procedures 1 or 2:

According to procedure 1, a cobalt-containing compound (C2) (alkyl-Cobalt (III) adduct), advantageously dissolved in an inert organic solvent, preferably an halogenated hydrocarbon, for instance dichloromethane and the like, is reacted with a nonhalogenated ethylenically unsaturated monomer, preferably a vinyl ester, more preferably vinyl acetate.

According to procedure 2, a cobalt (II) β-diketonate, preferably Co(acac)₂, is mixed with an oil-soluble azo initiator, preferably V-70, and the resulting mixture is reacted with a nonhalogenated ethylenically unsaturated monomer which is preferably a vinyl ester, more preferably vinyl acetate.

Procedures 1 and 2 may be carried out either before further polymerization steps involving at least one halogenated monomer (preformed compound (C3)) or in the polymerization reactor of at least one halogenated monomer (compound (C3) prepared in situ).

In accordance with the invention, any of the organo-cobalt complexes belonging to any of the three groups described hereabove is usable for the preparation of any halogenated homopolymer (a), any halogenated random copolymer (b1) and any halogenated block copolymer (b2). However, the cobalt (II) β-diketonates and the alkyl-cobalt (III) adducts (compounds (C2)) are preferred for the preparation of halogenated homopolymers (a); the alkyl-cobalt (III) adducts (compounds (C2)) are preferred for the preparation of halogenated random copolymers (b1); the cobalt-containing macroinitiators (C3) are preferred for the preparation of halogenated block copolymers (b2).

In accordance with the invention, any combination, in the medium in which the polymerization is carried out, of, on one side, compounds able to initiate the polymerization of the monomer(s), and, on the other side, organo-cobalt complexes, may be used. However, as stated above, compounds (C2) and (C3) are each preferably usable alone, working as initiating agents as well as propagating agents on their own. As far as compounds (C1) are concerned, they are advantageously better usable in combination with the first group of organo-cobalt complexes (the cobalt (II) β-diketonates), building in this way some kinds of redox-like couples (compound (C1) being the oxidant and the cobalt (II) β-diketonate (Lewis acid) being the reductor).

The respective amounts of compounds (C1) (when present), (C2) or (C3), of cobalt (II) β-diketonates in the medium in which the polymerization step is performed are not critical and may vary broadly.

Advantageously, the molar ratio between the monomer (or the mixture of monomers) and compound (C1) (when present), is comprised between 100/1 and 5000/1, preferably between 250/1 and 1500/1.

Advantageously, the molar ratio between the monomer (or the mixture of monomers) and compound (C2) or (C3), is comprised between 100/1 and 8000/1, preferably between 500/1 and 7000/1, more preferably between 1500/1 and 5000/1.

Advantageously, the molar ratio between the monomer (or the mixture of monomers), compound (C1) and the cobalt (II) β-diketonate, is comprised between 100/0,1-10/1 and 5000/0,1-10/1, preferably between 250/0,1-5/1 and 1500/0,5-5/1.

In accordance with the process of the invention, the polymerization step is carried out in non-isotherm conditions. In the present disclosure, the terms “non-isotherm conditions” must be understood as meaning that the temperature is progressively increased during the polymerization step. Applicants have actually surprinsingly observed that progressively increasing the polymerization temperature leads to resume and control the radical polymerization probably without willing to be binded by any theory whatsoever, by reactivating the carbon-cobalt bond end-capping the growing polymer chains in the form of a dormant species (Polymer-Co(β-diketonate)₂).

The polymerization step is carried out in non-isotherm conditions such that the polymerization temperature is advantageously progressively increased between 20 and 110° C., according to a temperature ramp which constant hourly increment is advantageously comprised between 2 and 20° C., preferably between 3 and 15° C., more preferably between 5 and 12° C. per hour. Preferably, the polymerization step is carried out in non-isotherm conditions such that the polymerization temperature is progressively increased between 25 and 100° C., according to a temperature ramp which constant hourly increment is advantageously comprised between 2 and 20° C., preferably between 3 and 15° C., more preferably between 5 and 12° C. per hour. More preferably, the polymerization step is carried out in non-isotherm conditions such that the polymerization temperature is progressively increased between 30 and 80° C., according to a temperature ramp which constant hourly increment is advantageously comprised between 2 and 20° C., preferably between 3 and 15° C., more preferably between 5 and 12° C. per hour.

In accordance with a particular mode of the invention, the polymerization step, complementary to be carried out in non-isotherm conditions, may be carried out in the presence of at least one ligand.

In the present disclosure, the terms “at least one ligand” mean that one or more different ligands may be present when the polymerization step is carried out. It is preferred, however, to carry out the polymerization step in the presence of one sole ligand.

In the present disclosure, the denomination “ligands” (called “ligand(s) L” hereafter and indifferently used in the singular or plural form) intends to define any atom, functional group or molecule, distinct from the β-diketonates ligands, able to coordinate the organo-cobalt complex, in particular able to coordinate the free coordination site of cobalt atom, and to build a coordination compound. Without willing to be binded by any theory whatsoever, Applicants believe that this coordination compound is able to resume and control the radical polymerization by reactivating the carbon-cobalt bond end-capping the growing polymer chains in the form of a dormant species (Polymer-Co(β-diketonate)₂). The excess of organo-cobalt complex is advantageously likely to be neutralized by the ligand L into a bis-adduct ligand. An example of such bis-adduct ligand L is shown by the following formula, in which the β-diketonate is the preferred acetylacetonate moiety:

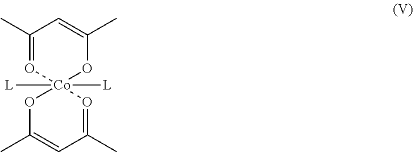

In accordance with the invention, ligand L is advantageously an organic Lewis base whose electron-pair donor (nucleophile) may coordinate the free coordination site of the cobalt central atom of the organo-cobalt complex. Preferred ligands L are water, dimethylformamide (DMF), dimethylsulfoxide (DMSO), pyridine, methanol, trimethylamine, ammonia and acrylonitrile. More preferred ligands L are water, DMF and DMSO. Most preferred ligands are water and DMF. When water is used as ligand L in a polymerization step performed in an aqueous medium, like a suspension process, the water working as ligand L is advantageously the part of the aqueous phase wherein the organo-cobalt complex diffuses from the monomer(s) droplets.

The ligand L may advantageously be added to the medium in which the polymerization step is carried out when the rate of propagation of the growing polymer chains slows down.

The respective amounts of compounds (C1) (when present), (C2) or (C3), of cobalt (II) β-diketonates and of ligands L in the medium in which the polymerization step is performed are not critical and may vary broadly.

Advantageously, the molar ratio between the ligand L and the organo-cobalt complex is comprised between 200/1 and 10/1, preferably between 100/1 and 25/1.

Thanks to the process of the invention, it is possible to initiate and control the radical polymerization in such a way as to synthesize, with an acceptable amount of conversion of the monomer(s), polymers (homopolymers or copolymers) free of structural defects along the polymer chains and as to shape their molecular architecture (molecular weights and molecular weight distribution) and macroscopic properties.

Should the disclosure of any patents, patent applications, and publications which are incorporated herein by reference conflict with the description of the present application to the extent that it may render a term unclear, the present description shall take precedence.

The examples which follow are intended to illustrate the invention without, however, limiting the scope thereof.

The features common to these examples are described hereunder.

### 1. Materials

VC (purity≧99.9%) was provided by Solvin SA and condensed under nitrogen pressure before the injection into the reactors.

Vinyl acetate (VAc) (purity≧99.9%) provided by Aldrich, was dried over calcium hydride, degassed by several freeze-pump-thawing cycles before being distilled under reduced pressure and stored under argon at −20° C.

Co(acac)₂ (purity: 99%) was provided by Acros

V-70 (t_{1/2}=2.5 hours at 40° C.) was provided by Wako.

2,2,6,6-tetramethyl-1-piperidinyl-1-oxy (TEMPO) (purity: 98%) was supplied by Aldrich.

Dilauryl peroxide (purity: 97%) was provided by Fluka.

Dichloromethane (purity≧99.5%) provided by Prolabo was dried over molecular sieves and degassed by bubbling argon for 30 minutes.

### 2. General Conditions of the VC Polymerization Tests

Stainless steel reactors of respectively 3 liters and 100 ml were used.

In both cases, VC was injected under nitrogen pressure into the reactors via stainless steel pipes. The amount of VC injected into the reactor was regulated by weighing the VC cylinder during the VC addition. A vertical agitating axe performed the agitation. When polymerizing, the agitation was about 200 rpm.

In the case of 3 liters reactors, each reactor had an independent heating system, thus allowing setting different temperatures and different polymerization times for each reactor. The addition of products once the reactor was closed and under VC pressure was also possible.

At the end of the polymerization, the reaction medium was cooled down to room temperature and unreacted VC was degassed thanks to pipes going from the reactor to vacuum evacuation through a bubbling bottle. When the degassing was over, a thermal treatment called “stripping” was carried out which consisted in blowing some nitrogen into the polymerization medium in order to remove VC that was not evacuated during degassing. At the end of this thermal treatment, the reactor was opened and the polymer recovered. Also, at the end of each polymerization, after the VC degassing and prior to the stripping, an excess of TEMPO (in solution in tetrahydrofuran (THF)) was added to the reactor in order to irreversibly terminate the polymerization. The nitroxyl radical irreversibly end-caps the polymer chain, releasing the cobalt complex. Therefore, when the stripping was carried out at the polymerization temperature, the polymer chains should not undergo further polymerization or side reactions.

### 3. Characterization

The number average molecular weight (Mn) and molecular weight distribution (Mw/Mn ratio) of the VC polymers were determined by size exclusion chromatography (SEC) in a DMF/lithium bromide solution (LiBr; 0.025 M; flow rate: 1 ml min⁻¹) at 55° C. using a Waters 600 liquid chromatograph equipped with a 2414 refractive index detector (RI) and four Styragel HR columns (HR1 (100-500), HR3 (500-30000), HR4 (5000-50000), HR5 (2000-4000000)). Calibration with poly(methyl-methacrylate) standards was used to determine the Mn of the polymers.

For SEC analysis, each sample was prepared as follows: 10 mg of polymer were dissolved in 2 ml of DMF-LiBr. The mixture was heated for 2 hours at 80° C. right before its injection.

The molecular weight of polyvinyl acetate (PVAc) was determined by SEC in THF (flow rate: 1 ml min⁻¹) at 40° C. using a Waters 600 liquid chromatograph equipped with a 410 refractive index detector (RI) and four Styragel HR columns (columns HPPL gel 5 μm, 10⁵, 10⁴, 10³ and 10² Å). Calibration with polystyrene standards was used to determine the Mn of the polymers.

Conversion of VC and of VAc was calculated by gravimetry.

### EXAMPLE 1R (COMPARATIVE EXAMPLE)

### Bulk Polymerization of Vinyl Chloride in the Presence of Co(Acac)₂ and V-70

3.2 g (1.25×10⁻² mol) of Co(acac)₂ and 4 g (1.29×10⁻² mol) of V-70 were added in a 3 liters stainless reactor and degassed by several vacuum-nitrogen cycles. 500 g (8 mol) of VC were then injected under nitrogen pressure. Molar ratios [Co(acac)₂]/[V70]/[VC] were: 1/1/643.

In a first test, the mixture was stirred and heated at 40° C. during 3 hours. At the end of the polymerization the reactor was cooled. After the cooling, the polymerization medium was degassed and then stripped. Finally, the reactor was opened and the polymer was recovered.

Only 8 mol % of VC were polymerized. The Mn (SEC) of the recovered PVC was 16500 g/mol. The Mw/Mn ratio (SEC) of the recovered PVC was 2.32.

In a second test, VC polymerization was performed for 6 hours at 40° C., 19 mol % of VC were polymerized. The Mn (SEC) of the recovered PVC was 21600 g/mol and the Mw/Mn ratio (SEC) was 2.48.

In a third test, VC polymerization was performed for 8 hours at 40° C., 18 mol % of VC were polymerized. The Mn (SEC) of the recovered PVC was 20100 g/mol and the Mw/Mn ratio (SEC) was 2.24.

Therefore, while the monomer conversion evolved from 3 to 6 hours of polymerization, with only a slight increase of molar masses, there was no further conversion when the polymerization time was extended to 8 hours. This indicates that the polymerization occurred within the first 6 hours and stopped at about 19% of VC conversion.

### EXAMPLE 2R (COMPARATIVE EXAMPLE)

### Bulk Polymerization of VAc in the Present of Co(Acac)₂ and V-70

0.0434 g (1.68 10⁻⁴ mol) of Co(acac)₂ and 0.052 g (1.68 10⁻⁴ mol) of V-70 were added in a 50 ml glass flask and degassed by several vacuum-nitrogen cycles. 9.34 g (0.108 mol) of dried and degassed VAc (dried over CaH₂ and distilled under vacuum) were then injected under nitrogen pressure. Molar ratios [Co(acac)₂]/[V70]/[VAc] were: 1/1/643.

The mixture was stirred and heated at 40° C. Samples were regularly picked out the reaction flask by a syringe under nitrogen for the determination of the VAc conversion and the molecular weight and molecular weight distribution analysis by SEC. Samples were deactivated by excess TEMPO prior to analysis.

The polymerization time (hour), the VAc conversion (%), the number average molecular weight (Mn) (g/mol) and the molecular weight distribution (polydispersity) (Mw/Mn ratio) are given in table 1 below.

TABLE 1

| Polym. Time (hour) | VAc conversion (%) | Mn (g/mol) | Mw/Mn |
|---|---|---|---|
| 16.4 | 4.6 | 3400 | 1.1 |
| 18.3 | 8.7 | 6200 | 1.07 |
| 21.4 | 19.2 | 12500 | 1.1 |
| 24 | 28.7 | 19000 | 1.14 |
| 25.4 | 34 | 22600 | 1.15 |
| 25.8 | 35.7 | 24200 | 1.12 |

From those data, it can be seen that the number average molecular weight (Mn) evolutes linearly with the VAc conversion putting in evidence the controlled character of the polymerization of VAc during which after 26 hours of polymerization, a Mn of 24200 g/mol was reached at 36% conversion.

In contrast with the polymerization of VC (example 1R), the polymerization of VAc gave access to a PVAc with well-defined molecular parameters (see in particular the very narrow molecular weight distribution (Mw/Mn ratio)).

### EXAMPLE 3R (COMPARATIVE EXAMPLE)

### Bulk Polymerization of Vinyl Chloride in the Presence of a Redox System Co(acac)₂/Dilauryl Peroxide.

Co(acac)₂ and dilauryl peroxide were added in a 100 ml stainless reactor degassed by several vacuum-nitrogen cycles. 0.96 mole of VC were then injected under nitrogen pressure.

Molar ratio [VC]/[Co(acac)₂] was 300/1

Molar ratio [Co(acac)₂]/[dilauryl peroxide] was 3/1.

The mixture was stirred and heated at 30° C. during 6 hours. At the end of the polymerization the reactor was cooled. After the cooling, the polymerization medium was degassed and then stripped. Finally, the reactor was opened and the polymer was recovered.

Only 9 mol % of VC were polymerized. The Mn (SEC) of the recovered PVC was 26600 g/mol. The Mw/Mn ratio (SEC) of the recovered PVC was 2.92.

### EXAMPLE 4 (ACCORDING TO THE INVENTION)

The bulk polymerization experiment of vinyl chloride in the presence of the redox system of Example 3R was repeated, excepted that it was carried out during 6 hours in non isotherm conditions: the polymerization temperature was progressively increased starting from 30° C., using a temperature ramp of 0.12° C./minute.

Under these conditions, as much as 40 mol % of VC were polymerized. The Mn (SEC) of the recovered PVC was 26900 g/mol. The Mw/Mn ratio (SEC) of the recovered PVC was 2.29.

### EXAMPLE 5R (COMPARATIVE EXAMPLE)

### A. Synthesis and Purification of an Alkyl-Cobalt (III) Adduct.

34 g of Co(acac)₂ (1.32×10⁻¹ mol) and 20 g of V-70 (6.5×10⁻² mol) were added in a 1 liter round-bottomed flask capped by a three-way stopcock and degassed by three vacuum-argon cycles. 100 ml of VAc (1.08 mol) were then added and the mixture was stirred and heated at 30° C. for about 70 hours. The medium remained pink throughout the reaction, with no increase in viscosity. The unreacted VAc was evaporated under reduced pressure at room temperature. The residual mixture was placed under argon and then diluted into dry and degassed dichloromethane, ready for purification by chromatographic separation under inert atmosphere. The solution was transferred with cannula to a silica-gel column placed under argon and equipped with a three-way stopcock at the bottom and with dry and degassed CH₂Cl₂ as eluent. After the elimination of V-70 residues (yellow colored) with CH₂Cl₂, a green fraction was collected with a CH₂Cl₂/C₂H₅OCOCH₃ (75:25) as eluent. Finally, the pink fraction corresponding to the alkyl-Co(III) compound (R₀—(CH₂—CHOAc)₄—Co(acac)₂ where R₀=primary radical from the V-70 decomposition) was collected with C₂H₅OCOCH₃ as eluent and was dried under vacuum. The alkyl-Co(III) compound was conserved under argon at −20° C. after dilution with 40 ml of degassed dichloromethane. The cobalt concentration (measured by inductively coupled plasma-mass spectroscopy (ICP-MS)) was 1.56×10⁻¹ mol/1.

The ICP-MS was carried with a spectrometer (Elan DRC-e Perkin-Elmer SCIEX). Samples were prepared by dissolving 1 ml of the alkyl-Co (III) compound solution (in dichloromethane, previously evaporated under vacuum) in 1 ml of HNO₃ (65%) at 60° C. for 2 hours. These solutions were diluted with 250 ml of bidistilled water at room temperature prior to ICP-MS analysis. An external calibration was necessary in order to determine the cobalt content.

### B. Bulk Polymerization of Vinyl Chloride Initiated by the Alkyl-Cobalt (III) Adduct.

2 ml of the alkyl-Co(III) solution in dichloromethane (Co(acac)₂=3.13×10⁻⁴ mol) were added in a 100 ml stainless reactor under nitrogen flux. The reactor was closed and the dichloromethane evaporated under vacuum for 15 minutes. The reactor was degassed by five vacuum-nitrogen cycles. 60 g of VC (0.96 mol) were then injected in the reactor under nitrogen pressure.

3 polymerization tests were carried out with a [VC]/[alkyl-Co(III)] ratio of 3250/1 and different durations (see Table 2 hereunder).

In each test, the mixture was stirred and heated at 40° C., and at the end of the polymerization, the reactor was degassed to eliminate the unreacted vinyl chloride. Then 20 ml of a 4.7×10⁻² mol/l of TEMPO solution was added to kill the reaction before stripping at 40° C. for two hours. The reactor was opened and the copolymer was recovered.

TABLE 2

| | [VC]/ | | | |
|---|---|---|---|---|
| Polym. time | [alkyl-Co(III)] | VC conversion | Mn (g/mol) | Mw/Mn |
| 1 h 30 | 3250:1 | 5% | 18 500 | 1.90 |
| 3 h 00 | 3250:1 | 4% | 15 000 | 1.98 |
| 6 h 00 | 3250:1 | 6% | 20 400 | 2.48 |

These data show that the VC conversion was very low after 1 h 30 of polymerization and did not further evolve (i.e. after 3 h and 6 h), suggesting that the polymerization stopped rapidly after the initiation, as observed with the V-70/Co(acac)₂ system tested in Example 1R and with the redox system Co(acac)₂/dilauryl peroxide tested in Example 3R.

### EXAMPLE 6 (ACCORDING TO THE INVENTION)

Polymerization tests were carried out as disclosed in example 5R, part B. but in non-isotherm conditions, by progressively increasing the temperature by using a temperature ramp of 0.12° C. min⁻¹ from 30° C. to 80° C.

The results are collected in Table 3 hereunder.

TABLE 3

| | [VC]/ | VC | Mn | |
|---|---|---|---|---|
| Polym. time | [alkyl-Co(III)] | conversion | (g/mol) | Mw/Mn |
| 1 h at 30° C. | 3250:1 | 7% | 27 500 | 2.95 |
| 1 h 30 = stop at 40° C. (*) | 3250:1 | 7% | 23 700 | 2.51 |
| 3 h 00 = stop at 51° C. | 3250:1 | 8% | 28 600 | 2.62 |
| 5 h 00 = stop at 65° C. | 3250:1 | 22% | 37 000 | 2.21 |
| 7 h 00 = stop at 80° C. | 3250:1 | 34% | 44 000 | 2.27 |

(*) means that starting at 30° C., the temperature was increased during 1 h 30 using a temperature ramp of 0.12° C., so till the temperature reached 40° C.

Table 3 clearly shows that the molar masses increased with time and thus with the temperature.

This VC polymerization presents characteristics of a controlled process when initiated by the alkyl-Co(III) compound in non-isotherm conditions. The PVC molecular weight increased with the monomer conversion when the polymerization temperature was gently increased. This observation is in sharp contrast with the conventional VC polymerization in which Mn decreases with the temperature, due to the occurrence of irreversible transfer reactions that are favored at high temperature.

1. A process for the preparation of a halogenated polymer comprising a controlled radical polymerization step of at least one monomer containing at least one halogen-carbon bond performed in the presence of an organo-cobalt complex, said polymerization step being further carried out in non-isotherm conditions.

2. The process according to claim 1, wherein the at least one monomer containing at least one halogen-carbon bond is vinyl chloride.

3. The process according to claim 1, for the preparation of a halogenated homopolymer comprising a controlled radical polymerization step of vinyl chloride.

4. The process according to claim 1, for the preparation of a halogenated random copolymer comprising a controlled radical polymerization step of a mixture of vinyl chloride and vinyl acetate.

5. The process according to claim 1, for the preparation of a halogenated block copolymer comprising sequential controlled radical polymerization steps of vinyl chloride, a preformed or in-situ formed cobalt-containing macroinitiator synthesized by cobalt-mediated radical polymerization of vinyl acetate and, optionally, vinyl acetate itself.

6. The process according to claim 1, wherein the controlled radical polymerization step is performed in bulk or in an aqueous medium.

7. The process according to claim 1, wherein the organo-cobalt complex is a cobalt β-diketonate.

8. The process according to claim 1, wherein the organo-cobalt complex is an alkyl-cobalt adduct.

9. The process according to claim 1, wherein the organo-cobalt complex is a cobalt-containing macroinitiator.

10. The process according to claim 1, wherein the polymerization step is carried out in non-isotherm conditions such that the polymerization temperature is progressively increased between 20 and 110° C. according to a temperature ramp which constant hourly increment is comprised between 2 and 20° C. per hour.

11. The process according to claim 1, wherein the polymerization step is carried out in non-isotherm conditions such that the polymerization temperature is progressively increased between 30 and 80° C. according to a temperature ramp which constant hourly increment is comprised between 2 and 20° C. per hour.

12. The halogenated polymer prepared in accordance with the process of claim 1.

13. The halogenated random copolymers prepared in accordance with the process of claim 4 and comprising at least 80 mole % by weight of monomeric units derived from vinyl chloride and at most 20 mole % by weight of monomeric units derived from vinyl acetate.

14. The halogenated block copolymers prepared in accordance with the process of claim 5 and comprising from 25 to 75 weight % of homopolymeric segments derived from vinyl chloride and 75 to 25 weight % of homopolymeric segments derived from vinyl acetate.

15. The halogenated block copolymers prepared in accordance with the process of claim 5 and comprising from 25 to 75 weight % of homopolymeric segments derived from vinyl chloride and 75 to 25 weight % of copolymeric segments randomly derived from vinyl chloride and vinyl acetate respectively presents in amounts of least 60 mole % of monomeric units derived from vinyl chloride and at most 40 mole % of monomeric units derived from vinyl acetate.
